(19) United States
(12) Patent Application Publication
(10) Pub. No.: US 2007/0271393 A1
(43) Pub. Date: Nov. 22, 2007

(54) System and Methods for Domain Name Acquisition and Management

(76) Inventor: John Wong, Philadelphia, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/579,477

(22) PCT Filed: May 5, 2005
(86) PCT No.: PCT/US05/15918

§ 371 Date: Nov. 3, 2006

Related U.S. Application Data
(60) Provisional application No. 60/568,187, filed on May 5, 2004.

(51) Int. Cl. G06F 15/16

(52) U.S. Cl. 709/245

(57) ABSTRACT

A method for managing domain name acquisition comprises collecting desired domain names in a shared database and matching the desired domain names in the shared database to those that are available as candidates for a registration status change. A registration is then changed of at least one matched desired domain name due to the matched desired domain name being in the shared database. The registration of the at least one matched desired domain name may be changed to an entity who desired said matched domain name wherein the said entity is associated with the domain name being caused to be collected in the shared database. The collecting of the domain names in the shared database may comprise receiving a backorder of a domain name from an entity desiring said domain name and then storing said backorder of the domain name in a shared database. A domain name auction scheme is also provided to attain the highest price of a desired domain name that may be a candidate for deletion from a registry.

### CROSS REFERENCE TO RELATED APPLICATIONS

This patent application is related to provisional patent application No. 60/568,187, filed May 5, 2004, entitled “Domain Name Acquisition and Management system and Method,” and priority is claimed to that application under 35 USC § 119(e).

### FIELD OF THE INVENTION

The present invention relates to the field of managing identification resources. More particularly, this invention relates to domain name registration and management on a distributed computer network, such as the Internet.

### BACKGROUND OF THE INVENTION

In distributed computer networks, being able to locate individual computers, servers, or various other machines on the network is critical. On the Internet, one of the most valuable identification resources is the domain name. Internet domain names provide a convenient way to reference Internet Protocol (IP) numerical addresses. Every “host” machine (e.g., computer, etc.) connected to the Internet must be identifiable by a specific numerical IP address. However, people prefer to reference host machines by pronounceable, easily remembered names, referred to as “domain names.” The Internet implements a Domain Name System (DNS) to facilitate matching specific domain names to specific hosts.

The DNS is a distributed database system that allows computer applications to map between domain names and IP addresses. The DNS also provides electronic mail routing information and many other services.

Physically, the DNS comprises many servers and other computers or machines that run software and store data permitting computers to query the DNS database. One such machine is the “root server.” A root server is a server computer that maintains the software and data necessary to locate “name servers” that contain authoritative data for a specific domain, such as the “.com” top level domain. Name servers are computers that have the software and data to resolve the domain name into an IP address. The data accessible through the name server is often referred to as a “zone file.” A “zone” is a subset of the total domain name space. The domain names in that subset are stored in the zone file for that name server. There is a zone file for each domain space (i.e., zone).

The DNS is organized in a hierarchical, tree structure. A domain name is the label representing a specific domain within the total possible domain space available in the DNS. The highest level in the DNS hierarchy is the “root,” which is technically unnamed but often referred to as the “.” or “dot.” The level immediately below the root in the DNS hierarchy is the top-level domain, or “TLD.” It is called the “top-level domain” because it is the highest level in the hierarchy after the root. The TLD appears furthest to the right in an English-language domain name. For example, “gov” in the “uspto.gov” domain name. There are various types of TLDs. The term “gTLD” is interchangeably used to refer to a “global top-level domain” or a “generic top-level domain.” A global TLD is one that can be registered by an entity regardless of the entity's geographic location or political boundary. For example, a person, corporation, or other entity located anywhere in the world can register a name in the “.com” domain. However, because an entity must have a presence in the United Kingdom to register a name in the “.uk” TLD, that domain is not a global TLD. Similarly, a generic TLD represents a domain in which an entity can register a name regardless of what type of entity it is.

By registering a domain name in a particular TLD, the TLD is sub-divided into lower levels in the DNS hierarchy. A second-level domain is the level in the DNS hierarch immediately below the TLD. An example of a second-level domain would be “snapnames” in the “snapnames.com” domain name. The level in the DNS hierarchy immediately below the second-level domain is the third-level domain. An example of the third-level domain would be “portland” in the “portland.or.us” domain name. Further subdivisions can be created in a similar manner. Domain names at each level of the hierarchy must be unique. Thus, while there can be only one snapnames registered in the “.com” TLD, there can be a “snapnames .net” domain name.

Historically, domain name registration has been conducted under a Shared Registration System (SRS). The SRS was created by Network Solutions, Inc. in 1999 to provide a registry backend through which multiple, globally diverse registrars could register domain names. The term “registry” refers to the entity responsible for managing allocation of domain names within a particular name space, such as a TLD. One example of a registry is the VeriSign, Inc. registry for the .com, .net, and .edu TLDs. The term “registrar” refers to any one of several entities with authority to add names to the registry for a name space. Entities that wish to register a domain name do so through a registrar. The term “registrant” refers to the entity registering the domain name. In some name spaces, the registry and registrar functions can be operated by the same entity, so as to combine the concepts and functions of the “registrar” and “registry.” The combined registry-registrar model is implemented in many ccTLDs and a few gTLDs. The overall registration system, including multiple registries, is overseen by the Internet Corporation for Assigned Names and Numbers (ICANN). ICANN is a non-profit corporation responsible for the IP address space allocation, protocol parameter assignment, domain name system management, and root server system management functions previously performed under U.S. Government contract by the Internet Assigned Numbers Authority (IANA) and other entities.

Domain names have become important assets for individuals, businesses, and organizations alike. At the same time, they are difficult to keep track of and can be lost in several ways. There are many examples of domain names being hi-jacked by hackers or cybersquatters with malicious intent. A disgruntled webmaster can walk away with a critical domain name. Domain names can be lost accidentally by a registrar. In addition, an owner simply forgetting to renew a subscription will often result in domain name loss.

Registration of available names is currently done on a first-come, first-served basis. Even after an entity registers a domain name, if they allow the registration to lapse, someone else may register the name. If an entity wishes to register a domain name that is currently registered to someone else, that entity would manually have to check the domain name registry with great frequency to ensure they will be the first to request registration of the name when it becomes available. If a registrant mistakenly forgets to renew the registration and the name becomes available, the former registrant would have to attempt to re-register the domain name as quickly as possible, before some other entity requests registration of that name. Registrants have never had an efficient and reliable system to prevent inadvertent loss of a domain name registration. Neither have registrants nor other interested entities had a means for ensuring successful registration of a domain name once it becomes available.

The Internet Corporation for Assigned Names and Numbers (ICANN) has introduced a “Redemption Grace Period” which provides a minimum 30-day period of time between the deletion of a domain name from the registry SRS and the time it becomes available for public registration. During the Redemption Grace Period, ICANN regulations permit retrieval of the domain by the most recent Registrant of the domain, and by no others. The 30-day redemption is typically followed by a 5-10 day period of time whereas the domain registry status becomes “delete-pending”, before finally being released by the registry for public registration.

To service customers who wish to acquire deleted domains, various services offer to capture the deleted domain name before anyone else captures it. Such services typically capture the domain name by sending a continuous, repetitious registration command for the said domain name at a very high rate of speed to the domain registry. Since the domains are allocated on a first-come-first-serve basis, the first successful registration command will become the acquirer of the said domain name.

In this regard there is a need for convenient and efficient systems and methods to service customers who wish to acquire soon to be deleted domain names and that do not send a continuous, repetitious registration command for the said domain name at a very high rate of speed to the domain registry.

### SUMMARY OF THE INVENTION

In consideration of the above-identified shortcomings of the art, the invention provides systems and methods for domain name acquisition and management. Provided is a method for managing domain name acquisition comprising collecting desired domain names in a shared database and matching the desired domain names in the shared database to those that are available as candidates for a registration status change. Finally a registration is changed of at least one matched desired domain name due to the matched desired domain name being in the shared database.

The registration of the at least one matched desired domain name may be changed to an entity who desired said matched domain name wherein the said entity is associated with the domain name being caused to be collected in the shared database. The collecting of the domain names in the shared database may comprise receiving a backorder of a domain name from an entity desiring said domain name and then storing said backorder of the domain name in a shared database.

### BRIEF DESCRIPTION OF THE DRAWINGS

The systems and methods for domain name acquisition and management in accordance with the invention are further described with reference to the accompanying drawings in which:

FIG. 1 is a flow chart illustrating a process of domain name management and acquisition;

FIG. 2 is a flow chart illustrating a process of domain name management and acquisition related to FIG. 1 in which a shared database indirectly effects a domain name transaction;

FIG. 3 is a flow chart illustrating a process of domain name management and acquisition related to FIGS. 1 and 2 wherein a distributed network program or architecture is used;

FIG. 4 is a system diagram illustrating relationships between entities of FIGS. 1 and 2;

FIG. 5 is a system diagram illustrating relationships between entities of FIG. 3;

FIG. 6 is a block diagram representing an exemplary computing device suitable for use in conjunction with various aspects of the invention; and

FIG. 7 illustrates an exemplary networked computing environment in which many computerized processes may be implemented in conjunction with various aspects of the invention.

### DETAILED DESCRIPTION OF ILLUSTRATIVE EMBODIMENTS

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the particular steps and sequences of steps should not be taken as required to practice this invention.

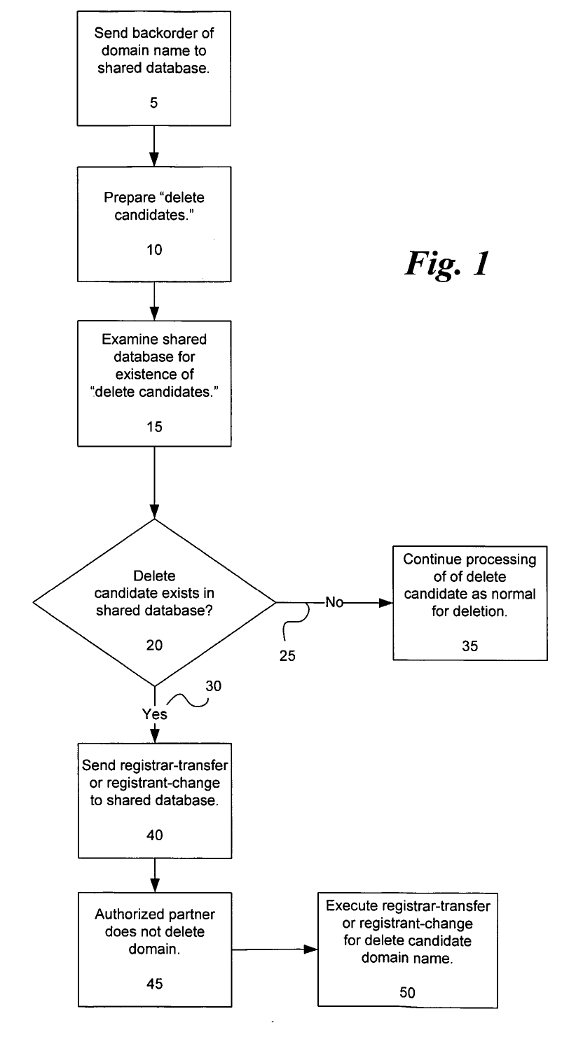

Referring first to FIG. 1, shown is a flow chart illustrating a process of domain name management and acquisition. An interested party (e.g., registrar or interested end-user) sends 5 a backorder for a domain name to a shared database. At some point, an Authorized Partner prepares 10 to delete expired or soon to be domain names (i.e., “delete candidates”) that are under its management authority. This preparation 10 to delete expired domain names may take place before, after or any time during the sending 5 of a backorder. The Authorized Partner examines 15 the current Shared Database for existence of any backorders for the delete candidate domain names. It is then determined 20 if the delete candidate exists in the shared database. This means that there was previously a backorder submitted for the domain name that is a candidate for deletion and perhaps instead of deleting the domain name from a registry it can be transferred to a party interested in acquiring it.

Therefore, if the delete candidate is found to exist 30 in the shared database, the Authorized Partner sends 40 a registrar-transfer or registrant-change notification directly to the shared database expressing its intention and permission to initiate, or permit, transfer of the delete candidate domain name to a new domain holder (e.g., a new registrant), or transfer the authority over the delete candidate domain name to a new maintainer (e.g., a new registrar). In this case, the Authorized Partner does not delete 45 the domain name. Then the shared database executes the registrar-transfer or registrant-change for the delete candidate domain name by communicating with the applicable registry of the delete candidate domain name to execute such an action.

However, if the delete candidate does not exist 25 in the shared database, this indicates that there was not previously a backorder submitted for the domain name that is a candidate for deletion and it may be deleted from the registry. The Authorized Partner who has current authority over the delete candidate then continues processing 35 of the delete candidate for deletion as normal.

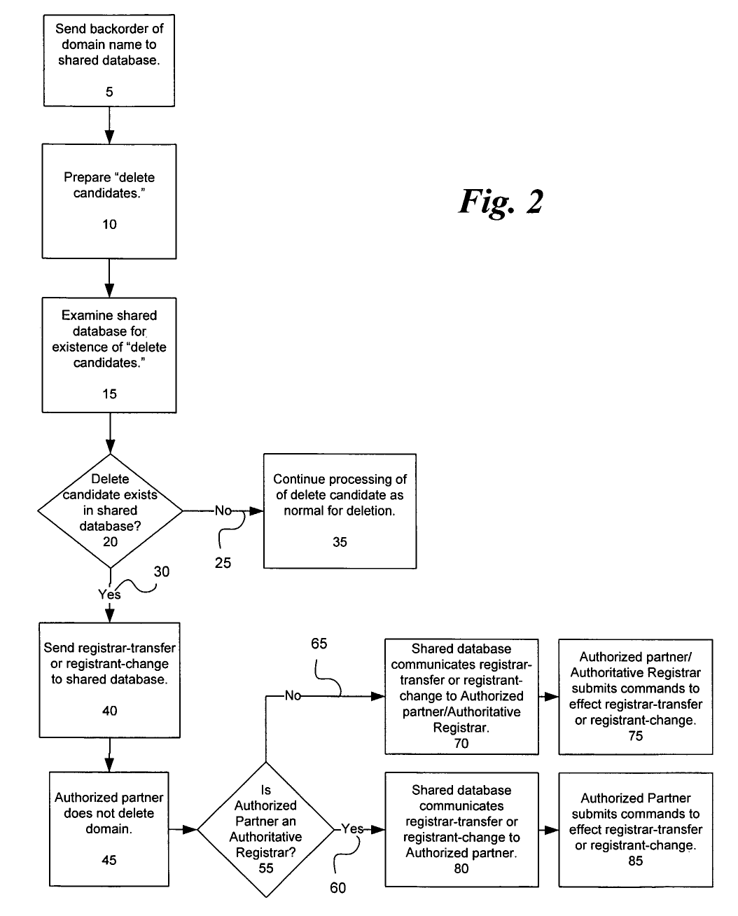

Referring next to FIG. 2, shown is a flow chart illustrating a process of domain name management and acquisition related to FIG. 1 in which a shared database indirectly effects a domain name transaction. In the process of FIG. 2, many acts are similar to those of FIG. 1. For example, an interested party (e.g., registrar or interested end-user) sends 5 a backorder for a domain name to a shared database. At some point, an Authorized Partner prepares 10 to delete expired or soon to be domain names (i.e., “delete candidates”) that are under its management authority. The Authorized Partner examines 15 the current Shared Database for existence of any backorders for the delete candidate domain names. It is then determined 20 if the delete candidate exists in the shared database. This means that there was previously a backorder submitted for the domain name that is candidate for deletion and perhaps instead of deleting the domain name from a registry it can be transferred to a party interested in acquiring it.

Therefore, if the delete candidate is found to exist 30 in the shared database, the Authorized Partner sends 40 a registrar-transfer or registrant-change notification directly to the shared database expressing its intention and permission to initiate, or permit, transfer of the delete candidate domain name to a new domain holder (e.g., a new registrant), or transfer the authority over the delete candidate domain name to a new maintainer (e.g., a new registrar). Here also, the Authorized Partner does not delete 45 the domain name.

However, additionally, a check is made to determine 55 if the Authorized Partner who's management authority the delete candidate domain name is under is also an Authoritative Registrar for that domain name. If it is determined that the Authorized Partner who's management authority the delete candidate is under is in fact also an Authoritative Registrar for that delete candidate domain name 60, then the shared database indirectly executes registrar-transfer or registrant-change for the delete candidate domain name by communicating 80 with the Authorized Partner who has current authority over the delete candidate domain. The Authorized Partner in turn submits 85 the necessary commands to the applicable Registry to effect such changes.

If it is determined that the Authorized Partner who's management authority the delete candidate is under is not also an Authoritative Registrar for that delete candidate domain name 65, then the shared database communicates 70 registrar-transfer or registrant-change to the Authorized partner/Authoritative Registrar. An example of this case is when Authorized Partner is a reseller but not the Authoritative Registrar for the delete candidate domain. The Authorized partner/Authoritative Registrar then submits commands to effect the registrar-transfer or registrant-change for the delete candidate domain name.

Likewise to that of FIG. 1, if the delete candidate does not exist 25 in the shared database, this indicates that there was not previously a backorder submitted for the domain name that is a candidate for deletion and it may be deleted from the registry. The Authorized Partner who has current authority over the delete candidate then continues processing 35 of the delete candidate for deletion as normal. Also, the shared database may be the same as, or operated by, the Authoritative Registry.

Alternatively, with respect to FIG. 1 or 2, various processes for determining the party to whom the delete candidate domain name should be sold other than the interested party (e.g., to a higher bidder) may occur after the interested party (e.g., registrar or interested end-user) sends 5 a backorder for a domain name to a shared database. This determining process may also occur directly before or directly after the Authorized Partner sends 40 a registrar-transfer or registrant-change notification directly to the shared database expressing its intention and permission to initiate, or permit, transfer of the delete candidate domain name to a new domain holder (e.g., a new registrant), or transfer the authority over the delete candidate domain name to a new maintainer (e.g., a new registrar). Such a determining process may be an auction activity to determine who is willing to pay the most for the delete candidate domain name at that time. Once it is determined who is willing to pay the most for the delete candidate domain name at that time, then the transfer of the delete candidate domain name is continued as shown in FIG. 1 or 2.

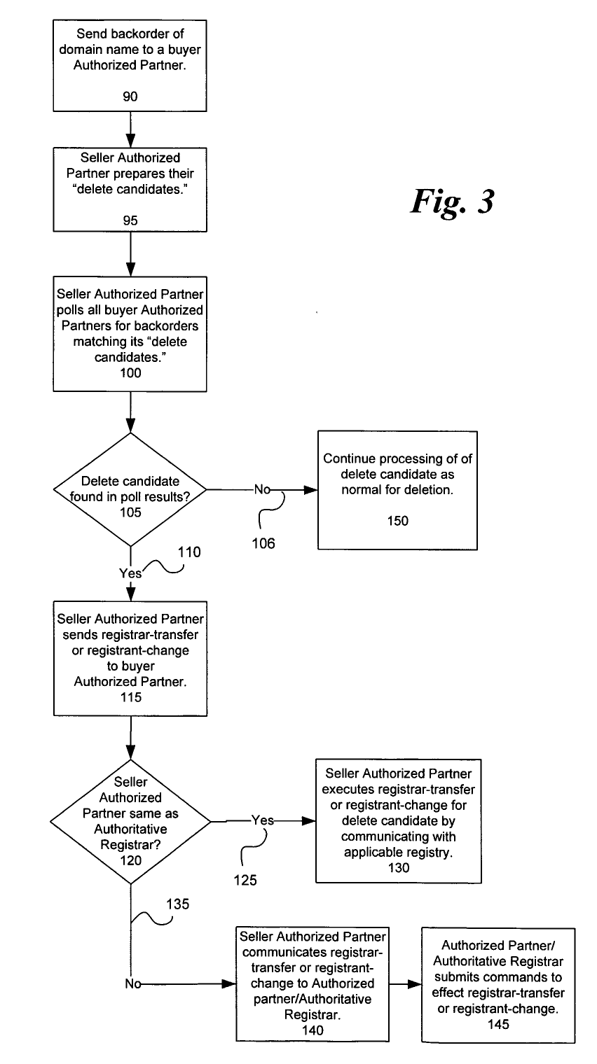

Referring next to FIG. 3, shown is a flow chart illustrating a process of domain name management and acquisition related to FIGS. 1 and 2 wherein a distributed network program or architecture is used. For example A peer-to-peer network or program (i.e., P-to-P or P2P) is a distributed network architecture wherein the participants share a part of their own hardware resources (processing power, storage capacity, network link capacity, printers). These shared resources are necessary to provide the service and content offered by the network (e.g. file sharing or shared workspaces for collaboration). They are accessible by other peers directly, without passing intermediary entities. The participants of such a network are thus resource (service and content) providers as well as resource (service and content) requesters. A peer-to-peer network is an example of a distributed network suitable for the process of domain name management and acquisition shown in FIG. 3. The peer-to-peer network allows communication and transaction directly between Authorized Partners to effect the redistribution of expired or expiring domain names.

An interested party (e.g., registrar or interested end-user) sends 90 a backorder to the first Authorized Partner (“buyer Authorized Partner”). At some point, the second Authorized Partner (“seller Authorized Partner”) prepares 95 to delete expired domains (“delete candidates”) that are under its management authority. This preparation 95 to delete expired domain names may take place before, after or any time during the sending 90 of a backorder. The seller Authorized Partner polls 100 all buyer Authorized Partners via peer-to-peer program (pp program), for example, seeking the existence of any backorders for delete candidate domains. Alternatively, the buyer Authorized Partner routinely sends a list of its existing backorders to all seller Authorized Partners on a regular schedule, and said temporary list is stored locally by each Seller Authorized Partner.

It is then determined 105 if the delete candidate exists in the poll results. If the delete candidate exists in the poll results, it means that there was previously a backorder submitted for the domain name that is a candidate for deletion and perhaps instead of deleting the domain name from a registry it can be transferred to a party interested in acquiring it.

Therefore, if the delete candidate is found to exist 110 in the poll results, the seller Authorized Partner sends 115 a registrar-transfer or registrant-change notification directly to the buyer Authorized Partner expressing its intention and permission to initiate, or permit, transfer of the said delete candidate domain name to a new domain holder (e.g., new registrant), or transfer the authority over the delete candidate domain name to a new maintainer (e.g., new registrar). Consequently, Seller Authorized Partner does not delete the domain.

If it is determined 120 that the seller Authorized Partner is the same 125 as the Authoritative Registrar for the delete candidate domain name, the seller Authorized Partner executes 130 the registrar-transfer or registrant-change for the delete candidate domain name by communicating with applicable registry. However, if the seller Authorized Partner is not the same 135 as the Authoritative Registrar for the delete candidate domain name, the seller Authorized Partner indirectly executes the registrar-transfer or registrant-change for the Delete Candidate Domain by communicating 140 the registrar-transfer or registrant-change to the Authorized Partner who is the Authoritative Registrar for the delete candidate domain name. The Authorized Partner then, in turn submits 145 the necessary commands to the applicable Registry to effect such changes.

If the delete candidate does not exist 106 in the poll results, the Authorized Partner who has current authority over the delete candidate domain name continues 150 processing of the delete candidate domain name in their normal fashion (e.g., the domain is deleted).

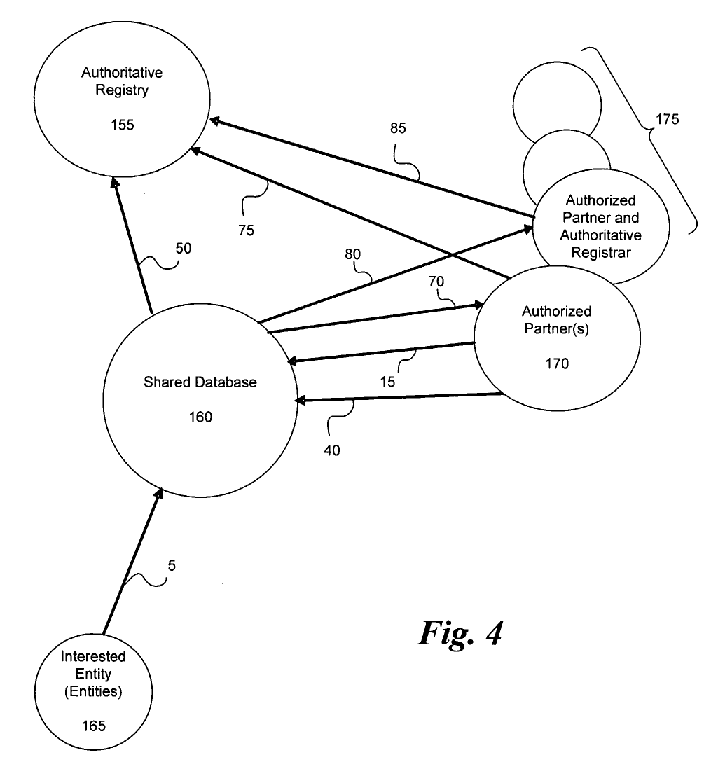

Referring next to FIG. 4, shown is a system diagram illustrating relationships and communication between entities of FIGS. 1 and 2. Shown is the Authoritative Registry 155, the shared database 160, the interested entity or entities 165, the Authorized Partner(s) 170, and the Authorized Partner(s) 175 who are also Authoritative Registrar(s) for particular domain names in the Authoritative Registry 155 and shared database 160. Communication lines 5, 15, 40, 50, 70, 75, 80, 85 depict the direction and location of logical communication between the entities of FIG. 4 and correspond to the acts with matching reference numerals in the flow charts of FIGS. 1 and 2.

For example, in FIG. 4 an interested entity 165 sends 15 a backorder to the shared database 160. The communication line depicting sending 15 the backorder corresponds to the act of sending 15 the backorder in the flowchart of FIG. 1.

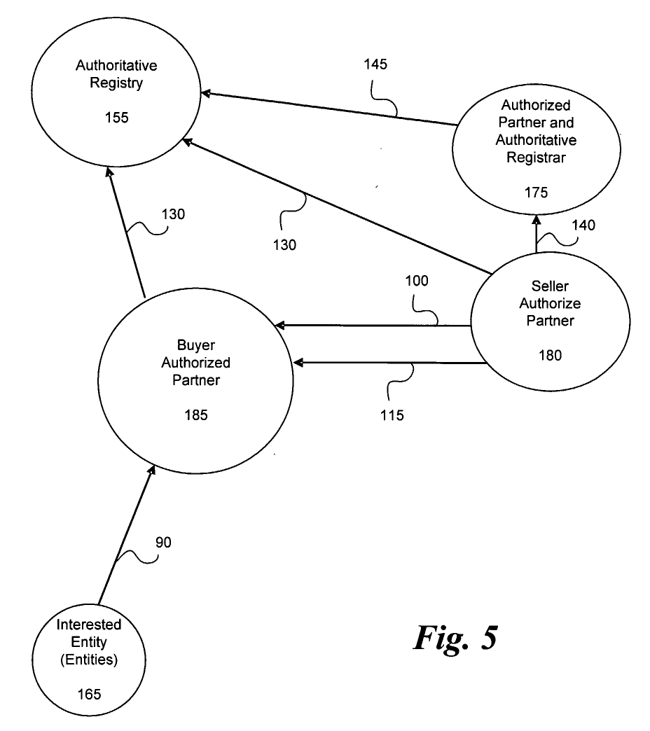

Referring next to FIG. 5, shown is a system diagram illustrating relationships and communication between entities of FIG. 3. Shown is the Authoritative Registry 155, the buyer Authorized Partner 185, the interested entity or entities 165, the seller Authorized Partner 180, and the Authorized Partner 175 who is also an Authoritative Registrar 175 for particular domain names in the Authoritative Registry 155. Communication lines 90, 100, 115, 130, 140, 145 depict the direction and location of logical communication between the entities of FIG. 5 and correspond to the acts with matching reference numerals in the flow chart of FIG. 3.

For example, in FIG. 5 the seller Authorized Partner 180 polls 100 all buyer Authorized Partners 185, seeking the existence of any backorders for delete candidate domain names. The communication line depicting polling 100 of the buyer Authorized Partners 185 corresponds to the act of polling 100 the buyer Authorized Partners 185 in the flowchart of FIG. 3.

Exemplary Computing and Network Environment

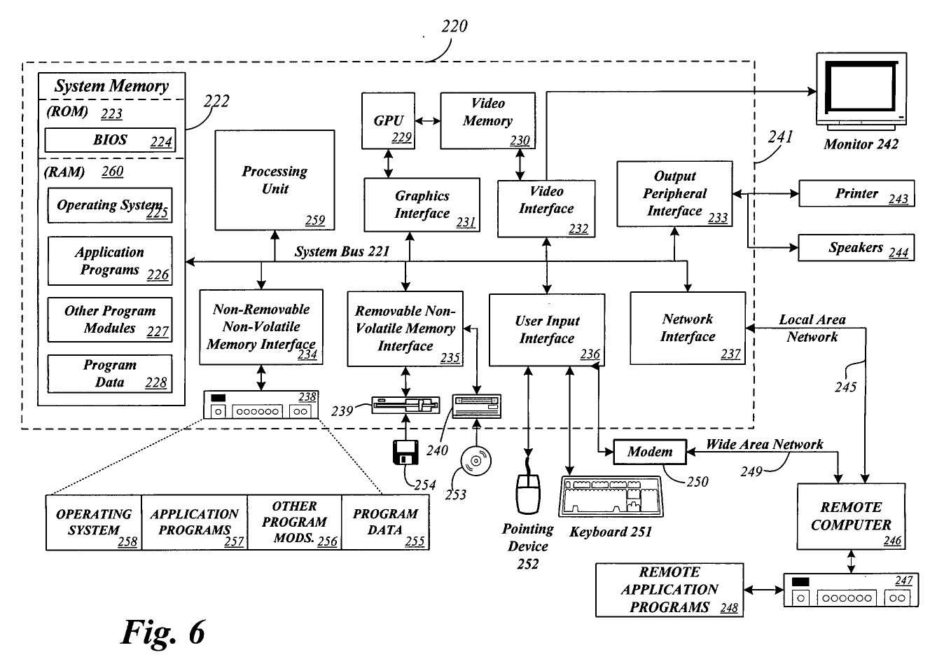

Referring to FIG. 6, shown is a block diagram representing an exemplary computing device suitable for use in conjunction with various aspects of the invention. For example, the computer executable instructions that carry out the processes and methods for domain name management and acquisition may reside and/or be executed in such a computing environment as shown in FIG. 6. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments such as a peer-to-peer network where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 6 illustrates operating system 225, application programs 226, other program modules 227, and program data 228.

The computer 241 may also include other removable/non-removable, volatile/nonvolatile computer storage media. By way of example only, FIG. 6 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 6, provide storage of computer readable instructions, data structures, program modules and other data for the computer 241. In FIG. 6, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 6. The logical connections depicted in FIG. 6 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 6 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

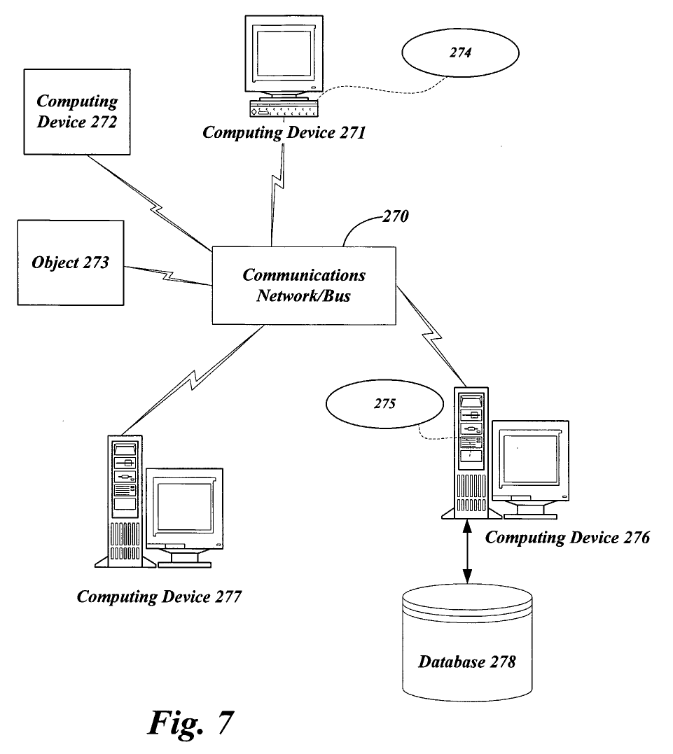

An exemplary networked computing environment is provided in FIG. 7. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 7 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 7, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 7, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 6 and the further diversification that can occur in computing in a network environment such as that of FIG. 7, the systems and methods provided herein cannot be construed as limited in any way to a particular computing architecture. Instead, the invention should not be limited to any single embodiment, but rather should be construed in breadth and scope in accordance with the appended claims.

1. A method for managing domain name acquisition comprising:
collecting desired domain names in a shared database;
matching the desired domain names in the shared database to those that are available as candidates for a registration status change;
causing registration of at least one matched desired domain name to change due to the matched desired domain name being in the shared database.

2. The method of claim 1 wherein the registration of the at least one matched desired domain name is changed to an entity who desired said matched domain name and said entity is associated with it being caused to be collected in the shared database.

3. The method of claim 1 wherein the collecting act comprises:
receiving a backorder of a domain name from an entity desiring said domain name; and
storing said backorder of the domain name in a shared database.

4. The method of claim 1 wherein the causing act comprises:
communicating domain name registration status change request information to the shared database; and
executing the registration status change of the desired domain name according to the domain name registration status change request information communicated to the shared database.

5. The method of claim 4, further comprising:
determining whether a first authorized partner who has rights to the matched domain name is also an authoritative registrar of the domain name such that the authorized partner has rights to directly modify a registry database of the matched domain name;
submitting commands to directly modify the registry database by the first authorized partner to execute the registration status change of the desired domain name according to domain name registration status change request information received by the shared database, if said first authorized partner has rights to directly modify a registry database of the matched domain name; and
submitting commands to directly modify the registry database by an second authorized partner who is also an authoritative registrar of the domain name such that the second authorized partner has rights to directly modify a registry database of the matched domain name to execute the registration status change of the desired domain name according to domain name registration status change request information received by the shared database, if said first authorized partner does not have rights to directly modify a registry database of the matched domain name.

6. The method of claim 1 wherein the shared database is operated by an authoritative registrar of the matched domain name such that the authoritative registrar has rights to directly modify a registry database of the matched domain name.

7. The method of claim 1 wherein the causing registration of at least one matched desired domain name to change due to the desired domain name being in the shared database comprises determining a party to whom a desired domain name should be sold based upon auctioning the desired domain name directly after the desired domain name is collected in the shared database.

8. The method of claim 1 wherein the causing registration of at least one matched desired domain name to change due to the matched desired domain name being in the shared database comprises determining a party to whom a desired domain name should be sold based upon auctioning the desired domain name directly after the desired domain name is collected in the shared database.

9. The method of claim 1 wherein the causing registration of at least one matched desired domain name to change due to the matched desired domain name being in the shared database comprises determining a party to whom a desired domain name should be sold based upon auctioning the desired domain name after the desired domain name is matched in the shared database to those that are available as candidates for a registration status change.

10. A method for managing domain name acquisition comprising:
matching desired domain names to those that are available as candidates for a registration status change by polling a plurality of potential buyer entities for indications by the buyer entities of the desired domain names; and
causing registration of at least one matched desired domain name to change due to the desired domain name existing in results of the polling.

11. The method of claim 10 wherein the registration of the at least one matched desired domain name is changed to an entity who desired said matched domain name and said entity is associated with it being caused to be returned in the results of the polling.

12. A computer readable medium comprising computer-executable instructions for performing the method of claim 1.

13. A computer readable medium comprising computer-executable instructions for performing the method of claim 2.

14. A computer readable medium comprising computer-executable instructions for performing the method of claim 3.

15. A computer readable medium comprising computer-executable instructions for performing the method of claim 4.

16. A computer readable medium comprising computer-executable instructions for performing the method of claim 5.

17. A computer readable medium comprising computer-executable instructions for performing the method of claim 6.

18. A computer readable medium comprising computer-executable instructions for performing the method of claim 7.

19. A computer readable medium comprising computer-executable instructions for performing the method of claim 8.

20. A computer readable medium comprising computer-executable instructions for performing the method of claim 9.

21. A computer readable medium comprising computer-executable instructions for performing the method of claim 10.

22. A computer readable medium comprising computer-executable instructions for performing the method of claim 11.

23. A computer readable medium comprising computer-executable instructions for performing the method of claim 12.

24. A system for managing domain name acquisition comprising:
means for collecting desired domain names in a shared database;
means for matching the desired domain names in the shared database to those that are available as candidates for a registration status change; and
means for causing registration of at least one matched desired domain name to change due to the matched desired domain name being in the shared database.

25. The system of claim 24 wherein the registration of the at least one matched desired domain name is changed to an entity who desired said matched domain name and said entity is associated with it being caused to be collected in the shared database.

26. The system of claim 24 wherein the collecting act comprises:
means for receiving a backorder of a domain name from an entity desiring said domain name; and
means for storing said backorder of the domain name in a shared database.

27. The system of claim 24 wherein the causing act comprises:
means for communicating domain name registration status change request information to the shared database; and
means for executing the registration status change of the desired domain name according to the domain name registration status change request information communicated to the shared database.

28. The system of claim 27, further comprising:
means for determining whether a first authorized partner who has rights to the matched domain name is also an authoritative registrar of the domain name such that the authorized partner has rights to directly modify a registry database of the matched domain name;
means for submitting commands to directly modify the registry database by the first authorized partner to execute the registration status change of the desired domain name according to domain name registration status change request information received by the shared database, if said first authorized partner has rights to directly modify a registry database of the matched domain name; and
means for submitting commands to directly modify the registry database by an second authorized partner who is also an authoritative registrar of the domain name such that the second authorized partner has rights to directly modify a registry database of the matched domain name to execute the registration status change of the desired domain name according to domain name registration status change request information received by the shared database, if said first authorized partner does not have rights to directly modify a registry database of the matched domain name.

29. The system of claim 24 wherein the shared database is operated by an authoritative registrar of the matched domain name such that the authoritative registrar has rights to directly modify a registry database of the matched domain name.

30. The system of claim 24 wherein the means for causing registration of at least one matched desired domain name to change due to the desired domain name being in the shared database comprises means for determining a party to whom a desired domain name should be sold based upon auctioning the desired domain name directly after the desired domain name is collected in the shared database.

31. The system of claim 24 wherein the means for causing registration of at least one matched desired domain name to change due to the matched desired domain name being in the shared database comprises means for determining a party to whom a desired domain name should be sold based upon auctioning the desired domain name directly after the desired domain name is collected in the shared database.

32. The system of claim 24 wherein the means for causing registration of at least one matched desired domain name to change due to the matched desired domain name being in the shared database comprises means for determining a party to whom a desired domain name should be sold based upon auctioning the desired domain name after the desired domain name is matched in the shared database to those that are available as candidates for a registration status change.

33. A system for managing domain name acquisition comprising:
means for matching desired domain names to those that are available as candidates for a registration status change by polling a plurality of potential buyer entities for indications by the buyer entities of the desired domain names; and
means for causing registration of at least one matched desired domain name to change due to the desired domain name existing in results of the polling.

34. The system of claim 33 wherein the registration of the at least one matched desired domain name is changed to an entity who desired said matched domain name and said entity is associated with it being caused to returned in the results of the polling.
